(19) United States
(12) Patent Application Publication
(10) Pub. No.: US 2010/0135254 A1
(43) Pub. Date: Jun. 3, 2010

(54) APPARATUS AND METHOD FOR REDUCING SIZE OF RANGING RESPONSE SIGNAL IN WIRELESS COMMUNICATION SYSTEM

(75) Inventor: Jin-Hyun Youn, Hanam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/629,541

(22) Filed: Dec. 2, 2009

(30) Foreign Application Priority Data
Dec. 2, 2008 (KR) 10-2008-0121002

(51) Int. Cl. H04W 4/00; H04W 36/00

(52) U.S. Cl. 370/331

(57) ABSTRACT

An apparatus and a method for performing network re-entry of a terminal in a base station of a wireless communication system are provided. In the method, when a RaNGing-REQuest (RNG-REQ) signal is received from the terminal, a Connection IDentifier (CID) is assigned to at least one Service Flow (SF) whose service providing is accepted of one or more SFs that have been serviced by the terminal. A bit map sequentially representing CID assignment information of SFs according to an SF index is generated. A RaNGing ReSPonse (RNG-RSP) signal including the bit map and the assigned CID information is generated. The RNG-RSP signal is transmitted to the terminal.

### PRIORITY

This application claims priority under 35 U.S.C. §119(a) to a Korean patent application filed in the Korean Intellectual Property Office on Dec. 2, 2008 and assigned Serial No. 10-2008-0121002, the entire disclosure of which is hereby incorporated by reference.

### BACKGROUND OF THE INVENTION

1. Field of the Invention

The present invention relates to an apparatus and a method for performing network re-entry of a terminal in a wireless communication system. More particularly, the present invention relates to an apparatus and a method for reducing a size of a RaNGing-ReSPonse (RNG-RSP) signal during network re-entry of a terminal in a wireless communication system.

2. Description of the Related Art

When a terminal switches from an idle mode to an active mode, or performs a handover in a wireless communication system, the terminal performs a network re-entry procedure. In this case, the terminal transmits/receives a RaNGing-REQuest (RNG-REQ) signal and a RNG-RSP signal to/from a base station to be re-accessed.

When transmitting a RNG-RSP signal, the base station assigns a new Transport Connection IDentifier (TCID) to a Service Flow (SF) in service. The base station then generates a RNG-RSP signal including TCID information assigned to the SF, and transmits the same to the terminal. For example, the base station generates a RNG-RSP signal using a compressed CID update scheme in order to reduce a size of a RNG-RSP signal.

When the compressed CID update scheme is used, the base station generates a RNG-RSP signal so that the RNG-RSP signal includes a bit map representing whether CIDs of SFs are assigned, and a TCID list.

When an n-th bit in a bit map of the RNG-RSP signal provided from the base station is set to 1, the terminal recognizes that a new TCID has been assigned to an n-th SF identifier of SF identifiers in service by the terminal. Therefore, the terminal determines a TCID of an n-th SF identifier from a TCID list.

As described above, when a compressed CID update scheme is used, the base station can reduce a size of the RNG-RSP signal.

The base station may accept only a portion of SFs that have been serviced by the terminal. In this case, a problem occurs in that a bit map of an SF transmitted by the base station via a RNG-RSP signal and an SF recognized by the terminal through a bit map become different. For example, in the case where a terminal is servicing SF ID 1, SF ID 2, and SF ID 3 but a base station accepts only SF ID 1 and SF ID 3, the base station assigns ID update information for SF ID 1 to a 0-th bit of a bit map included in a RNG-RSP signal, and assigns ID update information for SF ID 3 to a first bit. However, the terminal recognizes that ID update information for SF ID 1 is assigned to the 0-th bit of the bit map included in the RNG-RSP signal, ID update information for SF ID 2 is assigned to the first bit, and ID update information for SF ID 3 is assigned to a second bit. In this case, since a TCID assigned to SF ID 3 by the base station and TCID information of SF ID 3 recognized by the terminal are different, a service for SF ID 3 cannot be performed.

### SUMMARY OF THE INVENTION

The present invention is to address at least the above-mentioned problems and/or disadvantages and to provide at least the advantages described below. Accordingly, an aspect of the present invention is to provide an apparatus and a method for reducing a size of a RNG-RSP signal in a wireless communication system.

Another aspect of the present invention is to provide an apparatus and a method for allowing SFs recognized by a base station and a terminal to coincide with each other using a RNG-RSP signal generated according to a compressed CID update scheme in a wireless communication system.

Still another aspect of the present invention is to provide an apparatus and a method for assigning an SF index such that SFs recognized by a base station and a terminal coincide with each other using a RNG-RSP signal generated according to a compressed CID update scheme in a wireless communication system.

Yet another aspect of the present invention is to provide an apparatus and a method for assigning an SF ID and an SF index when an operation service is added in a wireless communication system.

In accordance with an aspect of the present invention, a method for controlling network re-entry of a terminal in a base station of a wireless communication system is provided. The method includes, when a RaNGing-REQuest (RNG-REQ) signal is received from the terminal, assigning a Connection IDentifier (CID) to at least one Service Flow (SF) whose service providing is accepted of one or more SFs that have been serviced by the terminal; generating a bit map sequentially representing CID assignment information of SFs according to an SF index; generating a RaNGing ReSPonse (RNG-RSP) signal including the bit map and the assigned CID information; and transmitting the RNG-RSP signal to the terminal.

In accordance with another aspect of the present invention, a method for performing network re-entry of a terminal in a wireless communication system is provided. The method includes transmitting a RaNGing-REQuest (RNG-REQ) signal to a base station to be accessed; when a RaNGing ReSPonse (RNG-RSP) signal is received from the base station, determining a bit map included in the RNG-RSP; and determining at least one Service Flow (SF) assigned Connection IDentifier (CID) by the base station and the CID from the bit map according to an SF index representing a bit map sequence of an SF.

In accordance with still another aspect of the present invention, an apparatus of a base station, for controlling network re-entry of a terminal in a wireless communication system is provided. The apparatus includes a receiver for receiving a signal; a controller for, when a RaNGing-REQuest (RNG-REQ) signal is received via the receiver, assigning a Connection IDentifier (CID) to at least one Service Flow (SF) whose service providing is accepted of one or more SFs which have been serviced by the terminal; and a transmitter for transmitting to the terminal a RaNGing-ReSPonse (RNG-RSP) signal including a bit map sequentially representing CID assignment information of an SF according to an SF index, and CID information assigned by the controller.

In accordance with further another aspect of the present invention, an apparatus of a terminal, for performing network re-entry in a wireless communication system is provided. The apparatus includes a transmitter for transmitting a RaNGing-REQuest (RNG-REQ) signal to a base station to be accessed; a receiver for receiving a signal; and a controller for, when a RaNGing-ReSPonse (RNG-RSP) signal is received via the receiver, determining at least one Service Flow (SF) assigned a Connection IDentifier (CID) by the base station and the CID from a bit map included in the RNG-RSP signal according to an SF index.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a diagram illustrating a procedure for assigning an SF index at a base station according to an embodiment of the present invention;

FIG. 2 is a diagram illustrating a procedure for assigning an SF index at a base station according to an embodiment of the present invention;

FIG. 3 is a diagram illustrating a procedure for transmitting an RNG-RSP signal at a base station according to an embodiment of the present invention;

FIG. 4 is a diagram illustrating a procedure for determining an identifier of an SF ID at a terminal according to an embodiment of the present invention;

FIG. 5 is a block diagram illustrating a base station in a wireless communication system according to an embodiment of the present invention; and

FIG. 6 is a block diagram illustrating a terminal in a wireless communication system according to an embodiment of the present invention.

Throughout the drawings, like reference numerals will be understood to refer to like parts, components and structures.

### DETAILED DESCRIPTION OF EMBODIMENTS OF THE PRESENT INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the dictionary meanings, but are merely used to enable a clear and consistent understanding of the invention. Accordingly, it should be apparent to those skilled in the art that the following description of embodiments of the present invention are provided for illustration purpose only and not for the purpose of limiting the invention as defined by the appended claims and their equivalents.

Embodiments of the present invention provide a technique for reducing a size of a RNG-RSP signal in a wireless communication system.

A terminal of a wireless communication system performs a network re-entry procedure when performing a handover or switching from an idle mode to an active mode. For example, when performing a network re-entry, a base station and a terminal transmit/receive a RNG-REQ signal and a RNG-RSP signal to/from each other. At this point, the base station generates a RNG-RSP signal using a compressed CID update scheme in order to reduce a size of the RNG-RSP signal.

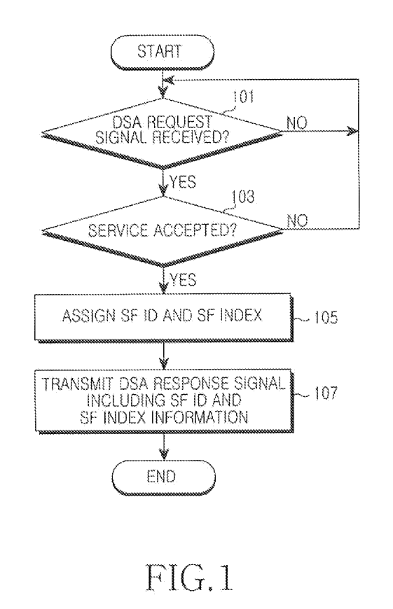

In the case of using the compressed CID update scheme, the base station generates a RNG-RSP signal so that the RNG-RSP signal includes a bit map representing the CID update information of the SF IDs and a CID list. At this point, the base station aligns the SF IDs according to an SF index to generate the bit map. The SF index is used as an index representing the SF in a bit map representing the CID update information. The SF index is assigned together with an SF ID during Dynamic Service Addition (DSA). For example, when a terminal requests DSA, a base station assigns an SF index as illustrated in FIG. 1.

FIG. 1 illustrates a procedure for assigning an SF index at a base station according to an embodiment of the present invention.

Referring to FIG. 1, in step 101 the base station determines whether a DSA request signal is received from a terminal that provides a service.

When a DSA request signal is received, in step 103 the base station determines whether to additionally assign a service to the terminal that has transmitted the DSA request signal. That is, the base station determines whether to additionally assign the service to the terminal in consideration of spare resources.

When not additionally assigning the service to the terminal, the base station determines again whether a DSA request signal is received in step 101. At this point, the base station informs the terminal that has requested the DSA that it cannot add the service via a DSA response signal.

In contrast, when additionally assigning the service, in step 105 the base station assigns an SF ID and an SF index for the service to be additionally assigned.

After assigning the SF ID and the SF index, in step 107 the base station transmits to the terminal a DSA response signal including the SF ID and the SF index for the service to be additionally assigned. For example, the base station generates a DSA response signal including an SF index a illustrated in Table 1.

TABLE 1

| Type | Length | Value |
|---|---|---|
| | 1 | SFID Index is used to make a BITMAP of |
| | | Compressed CID Update Encodings |
| | | TLV in REG-RSP Encoding TLV of RNG-RSP |
| | | message or REG-RSP message |

The base station then ends the process.

In the above-described embodiment of the present invention, the base station assigns an SF and an SF index to the terminal that has requested DSA.

In an exemplary embodiment of the present invention, the base station may assign an SF and an SF index to an arbitrary terminal through DSA even without a DSA request of a terminal.

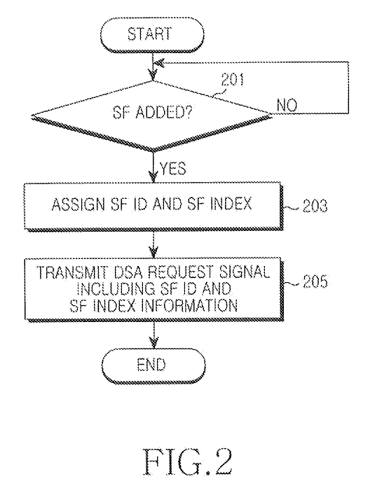

FIG. 2 illustrates a procedure for assigning an SF index at a base station according to an embodiment of the present invention.

Referring to FIG. 2, in step 201 the base station determines whether to add a service. The base station determines whether to add a service to a terminal in consideration of space resources.

When not adding a service to the terminal, the base station ends the process.

In the case of additionally assigning the service to the terminal, in step 203 the base station assigns an SF ID and an SF index of the service to be additionally assigned to the terminal.

After assigning the SF ID and the SF index, in step 205 the base station transmits a DSA request signal including the SF ID and the SF index of the service to be additionally assigned to the terminal. For example, the base station generates a DSA request signal including the SF index as illustrated in Table 1.

After that, the base station ends the process.

Hereinafter, a method for generating a RNG-RSP signal including an SF index at a base station is described.

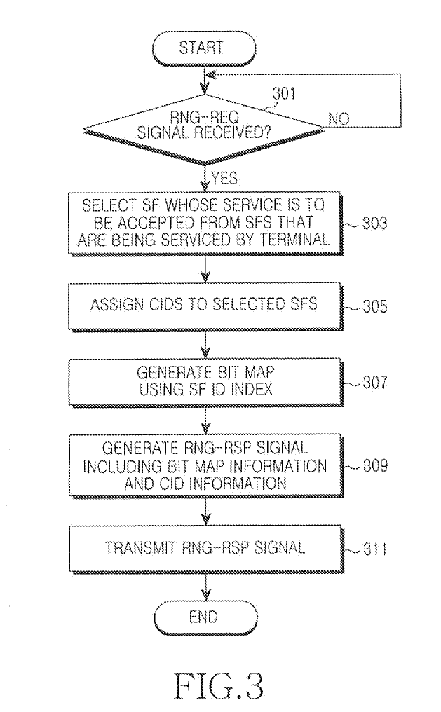

FIG. 3 is a diagram illustrating a procedure for transmitting a RNG-RSP signal at a base station according to an embodiment of the present invention.

Referring to FIG. 3, in step 301 the base station determines whether RNG-REQ signal is received.

When the RNG-REQ signal is received, in step 303 the base station determines at least one SF for a terminal that has transmitted the RNG-REQ signal. After that, the base station selects an SF whose service providing is to be accepted from SFs for the terminal. At this point, the base station may accept all or a portion of the SFs for the terminal. For example, in the case where the terminal is providing services with respect to SF ID 1, SF ID 2, and SF ID 3, the base station may accept only SF ID 1 and SF ID 3. Here, the SF for the terminal denotes the SF that is being serviced by the terminal.

In step 305 the base station assigns a new CID to the SFs that have, in step 303, accepted service providing. For example, in the case where the base station accepts only a portion of the SFs among the SFs for the terminal in step 303, the base station assigns a new CID to only the portion of the SFs accepted in step 303. Here, the CID includes a TCID.

After assigning a CID to the SFs, in step 307 the base station generates a bit map representing CID update information in consideration of an SF index for the SFs whose service providing, in step 303, has been accepted. At this point, the base station assigns the SFs whose service providing has been accepted according to an SF index to generate a bit map. For example, in the case of assigning a CID using SF ID 1 whose SF index is 1, SF ID 2 whose SF index is 2, SF ID 3 whose SF index is 3, and SF ID 4 whose SF index is 4, the base station generates a bit map of 1101. In the case of generating a bit map in 1 byte, the base station generates the bit map of 1101 0000.

After generating the bit map representing the CID update information, in step 309 the base station generates a RNG-RSP signal so that the RNG-RSP signal includes the bit map representing the CID update information and the CID list assigned in step 305. For example, the base station generates a RNG-RSP signal as illustrated in Table 2 below. Here, it is assumed that the base station assigns a CID of 1001 to SF ID 1 whose SF index is 1, assigns a CID of 1002 to SF ID 2 whose SF index is 2, and assigns a CID of 1004 to SF ID 4 whose SF index is 4 in step 305.

TABLE 2

| . | . |
|---|---|
| . | . |
| . | . |
| BITMAP'S length | 0x04 |
| BITMAP | 0xD0 |
| TCID list | 100110021004 |

A BITMAP's length field of the RNG-RSP signal represents a maximum value of an SF index. In a BITMAP field, a CID of the SFs assigned according to an SF index represents update information. The TCID list represents the CIDs assigned to the SFs.

After generating the RNG-RSP signal in step 309, in step 311 the base station transmits the RNG-RSP signal to the terminal in step 311.

After that, the base station ends the process.

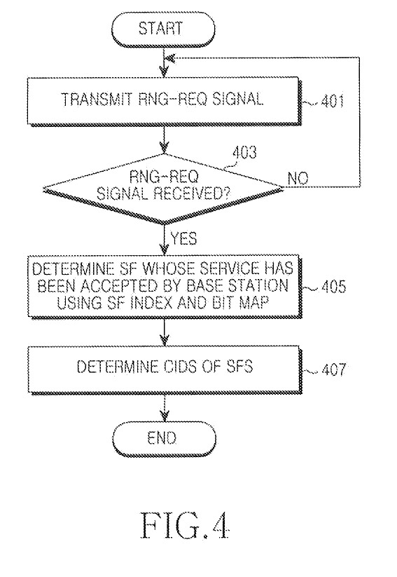

As described above, the base station generates a bit map including the CID update information according to an SF index. Therefore, the terminal can determine a CID of the SF assigned by the base station using an SF index as illustrated in FIG. 4.

FIG. 4 is a diagram illustrating a procedure for determining an identifier of an SF ID at a terminal according to an embodiment of the present invention.

Referring to FIG. 4, in step 401 the terminal transmits RNG-REQ signal to a base station to be accessed.

In step 403 the terminal determines whether a RNG-RSP signal to the transmitted RNG-REQ signal is received.

When the RNG-RSP signal is not received for a predetermined time, the terminal returns to step 401 to retransmit a RNG-REQ signal to the base station to be accessed. Though not shown, when having transmitted RNG-REQ signals a predetermined number of times, the terminal determines network re-entry has failed.

In contrast, when a RNG-RSP signal is received, in step 405 the terminal determines an SF assigned a CID by the base station using an SF index and a bit map included in the RNG-RSP signal. For example, when the bit map included in the RNG-RSP signal is ‘1101 0000’, the terminal recognizes that the CIDs for the SF whose SF index is 1, the SF whose SF index is 2, and the SF whose SF index is 4 are assigned by the base station.

After determining the SF assigned by the base station, in step 407 the terminal determines a CID assigned by the base station to each SF. For example, in the case where a RNG-RSP signal is generated as illustrated in Table 2, the terminal recognizes that a base station assigns a CID of SF ID 1 whose SF index is 1 using 1001, assigns a CID of SF ID 2 whose SF index is 2 using 1002, and assigns a CID of SF ID 4 using 1004.

After that, the terminal ends the process.

As described above, since the base station generates a bit map according to an SF index and the terminal determines a CID according to an SF index, the base station and the terminal can recognize the same SF and the same CID using a RNG-RSP signal.

Hereinafter, a construction of a base station for assigning an SF index and generating a RNG-RSP signal using the SF index is described. The following description is made on the assumption that the base station uses an OFDM scheme, but is applicable to a case of using a different communication scheme.

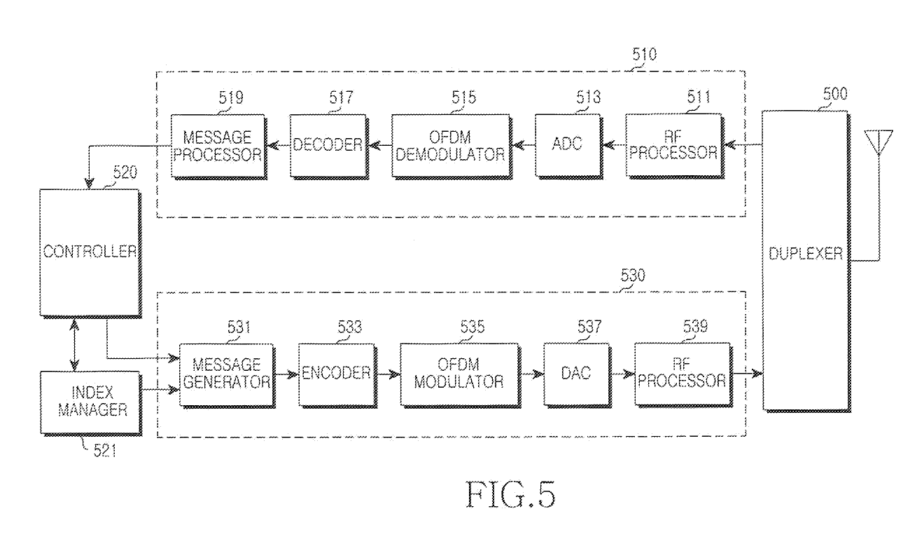

FIG. 5 is a block diagram illustrating a base station in a wireless communication system according to an embodiment of the present invention.

Referring to FIG. 5, the base station includes a duplexer 500, a receiver 510, a controller 520, and a transmitter 530.

The duplexer 500 transmits a transmission signal provided from the transmitter 530 via an antenna and provides a reception signal from the antenna to the receiver 510 according to a duplexing scheme. For example, iii the case of using a Time Division Duplexing (TDD) scheme, the duplexer 500 transmits a transmission signal provided from the transmitter 530 via the antenna during a transmission section, and provides a reception signal from the antenna to the receiver 510 during a reception section.

The receiver 510 includes a Radio Frequency (RF) processor 511, an Analog/Digital Converter (ADC) 513, an OFDM demodulator 515, a decoder 517, and a message processor 519.

The RF processor 511 converts an RF signal provided from the duplexer 500 into a baseband analog signal. The ADC 513 converts the analog signal provided from the RF processor 511 into digital sample data. The OFDM demodulator 515 converts the sample data in a time domain provided from the ADC 513 into data in a frequency domain by performing Fast Fourier Transform (FFT).

The decoder 517 selects data of subcarriers to be actually received from the data in the frequency domain provided from the OFDM demodulator 515. After that, the decoder 517 demodulates and decodes the selected data according to a predetermined Modulation and Coding Scheme (MCS) level.

The message processor 519 determines control information from a signal provided from the decoder 517, and transmits the determined control information to the controller 520. For example, the message processor 519 transmits a DSA request signal provided from the decoder 517, or control information included in a RNG-REQ signal to the controller 520.

The controller 520 allows the base station to control a network re-entry procedure of a terminal. At this point, the controller 520 controls to assign SF indexes to terminals. For example, the controller 520 controls to transmit an SF ID and an SF index of an added service to be provided to a terminal, to the terminal using a DSA request signal. For another example, when a terminal requests a DSA procedure, the controller 520 controls to provide an SF ID and an SF index of an added service to the terminal using a DSA response signal. At this point, the controller 520 transmits the SF index information assigned to each SF to an index manager 521.

The index manager 521 stores and manages the SF indexes assigned by the controller 520 to the SFs.

In addition, when a RNG-REQ signal is received from the message processor 519, the controller 520 determines the SF whose service is to be provided from the SFs that are being serviced by a terminal. In addition, the controller 520 assigns a new CID to the SF whose service providing has been accepted. For example, the controller 520 assigns a new TCID to all or a portion of the SFs whose service providing has been accepted.

The controller 520 controls a message generator 531 to generate a bit map representing CID update information in consideration of the SF indexes of the SFs to which CIDs have been assigned when generating a RNG-RSP signal.

The transmitter 530 includes the message generator 531, an encoder 533, an OFDM modulator 535, a Digital/Analog Converter (DAC) 537, and an RF processor 539.

The message generator 531 generates a control message under control of the controller 520. That is, the message generator 531 generates a message for assigning an SF index under control of the controller 520. For example, the message generator 531 generates a DSA request signal including an SF ID and an SF index of an added service. For another example, when a terminal requests a DSA procedure, the message generator 531 generates a DSA response signal including an SF ID and an SF index of an added service. At this point, the DSA request signal and the DSA response signal include the SF indexes as illustrated in Table 1.

The message generator 531 generates a RNG-RSP message in consideration of an SF index under control of the controller 520. For example, the message generator 531 assigns the SFs whose service providing has been accepted by the controller 520 according to the SF index information stored in the index manager 521 to generate a bit map representing the CID update information. After that, the message generator 531 generates a RNG-RSP message including the bit map and a CID list assigned by the controller 520.

The encoder 533 codes and modulates transmission data and a control message provided from the message generator 531 according to an MCS level. The OFDM modulator 535 converts data in the frequency domain provided from the encoder 533 into sample data (OFDM symbol) in the time domain by performing an Inverse Fast Fourier Transform (IFFT) process.

The DAC 537 converts the sample data provided from the OFDM modulator 535 into an analog signal. The RF processor 539 converts the analog signal in a baseband provided from the DAC 537 into an RF signal.

In the above construction, the controller 520 may perform a function of the index manager 521. Separate configuration and illustration of the index manager 521 in an embodiment of the present invention is for separately describing each function. Therefore, in actual realization, all or some of the functions of the index manager 521 may be processed by the controller 520.

Hereinafter, a construction of a terminal for determining an SF that is assigned a CID via a RNG-RSP signal using an SF index assigned by a base station will be described.

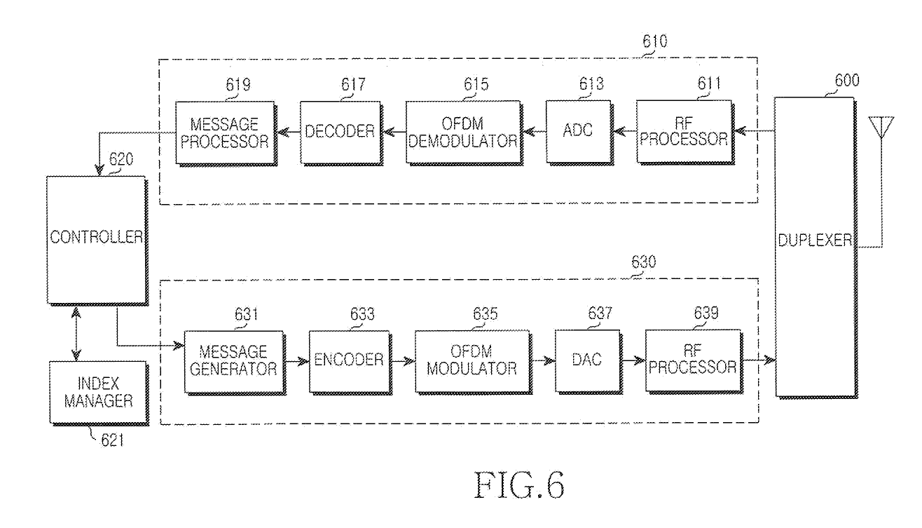

FIG. 6 is a block diagram illustrating a terminal in a wireless communication system according to an exemplary embodiment of the present invention.

Referring to FIG. 6, the terminal includes a duplexer 600, a receiver 610, a controller 620, and a transmitter 630.

The duplexer 600 transmits a transmission signal provided from the transmitter 630 via an antenna, and provides a reception signal from the antenna to the receiver 610 according to a duplexing scheme. For example, in the case of using a TDD scheme, the duplexer 600 transmits a transmission signal provided from the transmitter 630 via the antenna during a transmission section, and provides a reception signal from the antenna to the receiver 610 during a reception section.

The receiver 610 includes an RF processor 611, an ADC 613, an OFDM demodulator 615, a decoder 617, and a message processor 619.

The RF processor 611 converts an RF signal provided from the duplexer 600 into a baseband analog signal. The ADC 613 converts the analog signal provided from the RF processor 611 into digital sample data. The OFDM demodulator 615 converts the sample data in the time domain provided from the ADC 613 into data in the frequency domain by performing a Fast Fourier Transform (FFT) process.

The decoder 617 selects data of subcarriers to be actually received from the data in the frequency domain provided from the OFDM demodulator 615. After that, the decoder 617 demodulates and decodes the selected data according to a predetermined MCS level.

The message processor 619 determines control information from a signal provided from the decoder 617, and transmits the determined control information to the controller 620. For example, the message processor 619 transmits control information determined from a RNG-RSP signal provided by the decoder 617 to the controller 620. For another example, in the case where a base station requests a DSA procedure, the message processor 619 determines an SF ID and an SF index of an added service provided by the base station from a DSA request signal provided by the decoder 617, and transmits them to the controller 620. For another example, when requesting a base station to perform a DSA procedure, the message processor 619 determines an SF ID and an SF index of a service additionally provided by the base station from a DSA response signal, and transmits them to the controller 620.

The controller 620 controls the terminal to perform a network re-entry procedure. For example, the controller 620 transmits the SF IDs of the SFs provided from the message processor 619 to an index manager 621.

The index manager 621 stores and manages an SF index of the SF provided from the controller 620.

When a RNG-RSP signal is received from the message processor 619, the controller 620 determines the CIDs of the SFs assigned by the base station via the RNG-RSP signal using an SF index provided from the index manager 621. For example, in the case where a RNG-RSP signal is given as illustrated in Table 2, the controller 620 recognizes that a base station assigns a CID of SF ID 1 whose SF index is 1 using 1001, assigns a CID of SF ID 2 whose SF index is 2 using 1002, and assigns a CID of SF ID 4 using 1004.

The transmitter 630 includes a message generator 631, an encoder 633, an OFDM modulator 635, a DAC 637, and an RF processor 639.

The message generator 631 generates and outputs a control message under control of the controller 620. For example, the message generator 631 generates a DSA request message or a RNG-REQ message under control of the controller 620.

The encoder 633 encodes and modulates transmission data and a control message provided from the message generator 631 according to a relevant MCS level. The OFDM modulator 635 converts data in the frequency domain provided from the encoder 633 into sample data (OFDM symbol) in the time domain by performing IFFT.

The DAC 637 converts the sample data provided from the OFDM modulator 635 into an analog signal. The RF processor 639 converts the analog signal in the baseband provided from the DAC 637 into an RF signal.

In the above construction, the controller 620 may perform a function of the index manager 621. Separate configuration and illustration of the index manager 621 in an embodiment of the present invention is for separately describing each function. Therefore, in actual realization, all or some of the functions of the index manager 621 may be processed by the controller 620.

In the above embodiment of the present invention, the terminal is assigned an SF index through DSA. In an embodiment of the present invention, when the terminal operates in an idle mode, the terminal may be assigned an SF ID and an SF index through a paging message.

As described above, since a bit map is generated according to an SF index when s RNG-RSP signal is generated using a compressed CID assignment scheme in a wireless communication system, the SFs recognized by a base station and a terminal can be allowed to coincide with each other using the RNG-RSP signal, and a size of the RNG-RSP signal can be reduced.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for controlling network re-entry of a terminal in a base station of a wireless communication system, the method comprising the steps of:
when a RaNGing-REQuest (RNG-REQ) signal is received from the terminal, assigning a Connection IDentifier (CID) to at least one Service Flow (SF) whose service is accepted from one or more SFs that have been serviced by the terminal;
generating a bit map sequentially representing CID assignment information of the SFs according to an SF index;
generating a RaNGing ReSPonse (RNG-RSP) signal comprising the bit map and the assigned CID information; and
transmitting the RNG-RSP signal to the terminal.

2. The method of claim 1, wherein the assigning of the CID comprises:
selecting at least one SF whose service is accepted from the one or more SFs that have been serviced by the terminal; and
assigning a Transport Connection ID (TCID) to at least one SF of the selected SFs.

3. The method of claim 1, wherein the generating of the RNG-RSP signal comprises generating a RNG-RSP signal, which includes a CID list that sequentially lists CIDs assigned to the SFs according to a construction sequence of the bit map, and the bit map.

4. The method of claim 1, wherein the RNG-RSP signal further comprises bit map length information representing a maximum value of the SF indexes.

5. The method of claim 1, further comprising:
when a Dynamic Service Addition (DSA) request signal is received from the terminal, determining whether to add a service to the terminal;
when it is determined that the service is added to the terminal, assigning an SF ID and an SF index of the added service to the terminal;
generating a DSA response signal comprising the SF ID and the SF index information; and
transmitting the DSA response signal to the terminal.

6. The method of claim 1, further comprising:
when it is determined that the service is added to the terminal, assigning an SF ID and an SF index of the added service to the terminal;
generating a DSA request signal comprising the SF ID and the SF index information; and
transmitting the DSA request signal to the terminal.

7. A method for performing network re-entry of a terminal in a wireless communication system, the method comprising the steps of:
transmitting a RaNGing-REQuest (RNG-REQ) signal to a base station to be accessed;
when a RaNGing ReSPonse (RNG-RSP) signal is received from the base station, determining a bit map included in the RNG-RSP; and
determining at least one Service Flow (SF) assigned a Connection IDentifier (CID) by the base station and the CID from the bit map according to an SF index representing a bit map sequence of an SF.

8. The method of claim 7, further comprising, when the base station requests Dynamic Service Addition (DSA) before the RNG-REQ signal is transmitted, determining an SF ID and an SF index of an added service via a DSA request signal received from the base station.

9. The method of claim 7, further comprising, when requesting the base station to add Dynamic Service (DS) before the RNG-REQ signal is transmitted, determining an SF ID and an SF index of the service added by the base station via a DSA response signal received from the base station.

10. The method of claim 7, further comprising, when the terminal operates in an idle mode before transmitting the RNG-REQ signal, determining an SF ID and an SF index from a paging signal.

11. An apparatus of a base station, for controlling network re-entry of a terminal in a wireless communication system, the apparatus comprising:
a receiver for receiving a signal;
a controller for, when a RaNGing-REQuest (RNG-REQ) signal is received via the receiver, assigning a Connection IDentifier (CID) to at least one Service Flow (SF) whose service is accepted from one or more SFs which have been serviced by the terminal; and
a transmitter for transmitting a RaNGing-ReSPonse (RNG-RSP) signal comprising a bit map sequentially representing CID assignment information of the SF according to an SF index, and CID information assigned by the controller, to the terminal.

12. The apparatus of claim 11, wherein the controller selects at least one SF whose service is accepted from the one or more SFs that have been serviced by the terminal, and assigns a Transport Connection IDentifier (TCID) to at least one SF of the selected SFs.

13. The apparatus of claim 11, wherein the transmitter comprises:
a message generator for generating a RNG-RSP signal comprising the bit map sequentially representing the CID assignment information of the SF according to an SF index, and the CID information assigned by the controller; and
a transmitter for transmitting the RNG-RSP signal to the terminal.

14. The apparatus of claim 11, wherein the transmitter generates a RNG-RSP signal comprising the bit map sequentially representing the CID assignment information of the SF according to the SF index, and a CID list that sequentially lists CIDs assigned to the SFs according to a construction sequence of the bit map.

15. The apparatus of claim 11, wherein when a Dynamic Service Addition (DSA) request signal is received via the receiver, the controller determines whether to add a service to a terminal that has transmitted the DSA request signal, and when it is determined that the service is added to the terminal, the controller assigns an SF ID and an SF index to the added service.

16. The apparatus of claim 15, wherein the transmitter generates a DSA response signal comprising the SF ID and the SF index information of the added service assigned by the controller, and transmits the generated DSA response signal to the terminal.

17. The apparatus of claim 15, wherein when it is determined that the service is added to the terminal, the controller assigns the SF ID and the SF index of the added service to the terminal.

18. The apparatus of claim 17, wherein the transmitter generates a DSA request signal comprising the SF ID and the SF index information of the added service assigned by the controller, and transmits the generated DSA request signal to the terminal.

19. An apparatus of a terminal, for performing network re-entry in a wireless communication system, the apparatus comprising:
a transmitter for transmitting a RaNGing-REQuest (RNG-REQ) signal to a base station to be accessed;
a receiver for receiving a signal; and
a controller for, when a RaNGing-ReSPonse (RNG-RSP) signal is received via the receiver, determining at least one Service Flow (SF) assigned a Connection IDentifier (CID) by the base station and the CID from a bit map included in the RNG-RSP signal according to an SF index.

20. The apparatus of claim 19, wherein when a Dynamic Service Addition (DSA) request signal is received via the receiver, the controller determines an SF ID and an SF index of an added service via the DSA request signal.

21. The apparatus of claim 19, wherein when a DSA response signal is received via the receiver, the controller determines an SF ID and an SF index of an added service via the DSA response signal.

22. The apparatus of claim 19, wherein when the terminal operates in an idle mode, the controller determines an SF ID and an SF index from a paging signal received via the receiver.
